(19) United States
(12) Patent Application Publication
(10) Pub. No.: US 2002/0089226 A1
(43) Pub. Date: Jul. 11, 2002

(54) Arrangement for adjusting the inclination of a seat backrest

(76) Inventor: Nikolaus Haller, Ammerthal (DE)

Correspondence Address: CARELLA, BYRNE, BAIN, GILFILLAN, CECCHI,, STEWART & OLSTEIN, 6 BECKER FARM ROAD, ROSELAND, NJ, 07068, US

(21) Appl. No.: 09/924,618

(22) Filed: Aug. 8, 2001

(30) Foreign Application Priority Data
Aug. 10, 2000 (DE) 10039042.0

(51) Int. Cl. B60N 2/22

(52) U.S. Cl. 297/378.12

(57) ABSTRACT

In an arrangement for adjusting the inclination of a backrest in relation to a backrest squab of a seat such as a vehicle seat, the backrest or the seat squab carries a spring plate having a tooth configuration and the seat plate or the backrest respectively carries a counterpart member which is fixed with respect to the seat and which is provided with a counterpart tooth configuration corresponding to the tooth configuration of the spring plate. In the normal arresting position of the arrangement the tooth configuration of the spring plate engages into the counterpart tooth configuration of the counterpart member. Associated with the spring plate is an actuating device displaceable between a retaining position and a release position. By means of the actuating device the tooth configuration of the spring plate in the release position is disengageable laterally in the axial direction of the teeth out of the counterpart tooth configuration of the counterpart member.

### FIELD OF THE INVENTION

The invention generally concerns an arrangement for adjusting the inclination of a backrest in relation to a seat squab of a seat, more particularly a vehicle seat.

### BACKGROUND OF THE INVENTION

A typical arrangement for adjusting the inclination of the backrest of a motor vehicle seat comprises a rotary knob disposed at the side of the seat. When the rotary knob is rotated in one direction or the other, the backrest is adjusted in respect of its inclination according to the wish of the occupant of the seat, by means of a transmission assembly connected to the rotary knob. Although such an adjusting arrangement permits the inclination of the backrest to be precisely adjusted, the adjustment operation itself, by virtue of necessitating prolonged rotation of the rotary knob, is however time-consuming.

In another form of adjusting arrangement for adjusting the inclination of the backrest of a vehicle seat in relation to its seat squab, the structure comprises a first member having a tooth configuration and a counterpart member with a counterpart tooth configuration arranged to cooperate with the tooth configuration of the first-mentioned member. Thus, in the normal arrested position of the backrest in relation to the seat squab, the tooth configuration of the first-mentioned member engages into the counterpart tooth configuration of the counterpart member which is fixed with respect to the seat. To adjust the inclination of the backrest with that arrangement, it is necessary for the first-mentioned member to be moved in the radial direction out of the counterpart tooth configuration of the counterpart member which is fixed with respect to the seat. It has been found that it is often not possible to avoid rattling noises, in particular after the arrangement has been in use for a prolonged period of time.

### SUMMARY OF THE INVENTION

An object of the present invention is to provide an arrangement for adjusting the inclination of a backrest of a seat in relation to the seat squab, which is of a simple structure and which operates highly reliably even after a long service life.

Another object of the present invention is to provide a backrest inclination-adjustment arrangement with enhanced simplicity of operation without that entailing a complicated structure to achieve that aim.

Still another object of the present invention is to provide an arrangement for adjusting backrest inclination of a seat relative to the seat squab which provides for easy and ready adjustment while at the same time ensuring that the backrest is reliably locked in the adjusted position.

In accordance with the principles of the present invention the foregoing and other objects are attained by an arrangement for adjusting the inclination of a backrest of a seat in relation to the seat squab, for example in a vehicle seat, comprising a spring plate having a tooth configuration, the spring plate being mounted to the backrest of the seat or to the seat squab. Mounted to the seat squab or to the backrest respectively is a counterpart member which is fixed with respect to the seat and which has a counterpart tooth configuration co-operable with the tooth configuration on the spring plate. In the normal arresting position of the arrangement the tooth configuration on the spring plate engages without play into the counterpart tooth configuration on the counterpart member. Operatively associated with the spring plate is an actuating device which is displaceable between a retaining position and a release position, the actuating device being operable in the release position thereof to disengage the tooth configuration of the spring plate laterally axially in relation to the teeth out of the counterpart tooth configuration of the counterpart member.

As will be seen in greater detail from preferred embodiments of the arrangement according to the invention as described hereinafter, the arrangement according to the invention therefore provides that it is not a first member with its tooth configuration which is disengaged in a radial direction from the counterpart tooth configuration of the fixed counterpart member in order to be able to adjust the backrest as desired in relation to the seat squab, but rather the above-mentioned spring plate is disengaged laterally, that is to say axially in relation to its teeth, out of the counterpart tooth configuration of the counterpart member, by means of the actuating device. When the actuating device is released again, the spring member automatically springs back again, in which case its tooth configuration comes into latching engagement with the counterpart tooth configuration of the counterpart member.

In a preferred feature of the invention the counterpart member, the spring plate and the actuating device operatively associated with the spring plate are mounted to a seat fitment. The backrest is pivotably connected to the seat squab in the usual fashion by means of that seat fitment.

A preferred feature of the arrangement according to the invention provides that the spring plate includes a fixing portion fixed to the seat fitment. The counterpart member which is fixed with respect to the seat can be fixed to the seat fitment or can be an integral component portion thereof.

In a further preferred feature the actuating device of the arrangement of the invention can have a shaft mounted on the seat fitment, with an adjustment cam bearing against the spring plate. Another possible design configuration in this respect provides that the actuating device includes a pivot lever with pressure elements, while the spring plate has wedge-shaped ribs, the pressure elements and the ribs being disposed along coincident circle portions. Yet another alternative structure provides that the spring plate carries a taper portion and the actuating device includes a sliding lever with a pressure member which is slidable along the taper portion.

In a further advantageous feature of the invention the tooth configuration of the spring plate and the counterpart tooth configuration of the counterpart member include an acute angle with the common axis of the tooth configurations. That acute angle can be for example of the order of magnitude of between 5 and 10 degrees of angle. It will be appreciated that the acute angle may also be larger or smaller.

Such a configuration of the last-mentioned kind affords the further advantage that, upon wear of the teeth of the tooth configuration of the spring plate and/or the counterpart tooth configuration, as often is inevitable after a long service life, automatic take-up adjustment of the tooth configurations is achieved in relation to each other.

It has proven to be advantageous if the acute angle is increased in the direction of opening of the spring plate in such a way that a self-locking action occurs in the retaining position. That can make it possible to achieve optimum operational reliability.

In order to achieve more optimum engagement of the tooth configuration on the spring plate into the co-operable counterpart tooth configuration, a further preferred feature of the invention provides that the tooth configuration and the counterpart tooth configuration are rounded at the transition between their tooth flanks which face towards each other in the release position and the tooth tips.

Further objects, features and advantages of the invention will be apparent from the description hereinafter of preferred embodiments of the arrangement according to the invention.

### BRIEF DESCRIPTION OF THE DRAWING

FIG. 1 is a side view of a diagrammatically illustrated vehicle seat,

FIG. 2 is a sectional view of a portion of a first embodiment of the adjusting arrangement,

FIG. 3 is a sectional view similar to FIG. 2 showing a portion of a second embodiment of the adjusting arrangement,

FIG. 4 is a view of the spring plate and the counterpart member of which portions are shown, viewing in the direction of the arrows IV-IV in FIG. 3, indicating a pivot lever of the adjusting arrangement by thin double dot-dashed lines,

FIG. 5 is a sectional view similar to FIGS. 2 and 3 of a third embodiment showing a portion of the adjusting arrangement according to the invention with a sliding lever,

FIG. 6 is a view on an enlarged scale showing the detail indicated at VI in FIG. 2, in the release position of the spring plate, and

FIG. 7 is a view similar to FIG. 6, with the spring plate in the retaining position.

### DESCRIPTION OF PREFERRED EMBODIMENTS

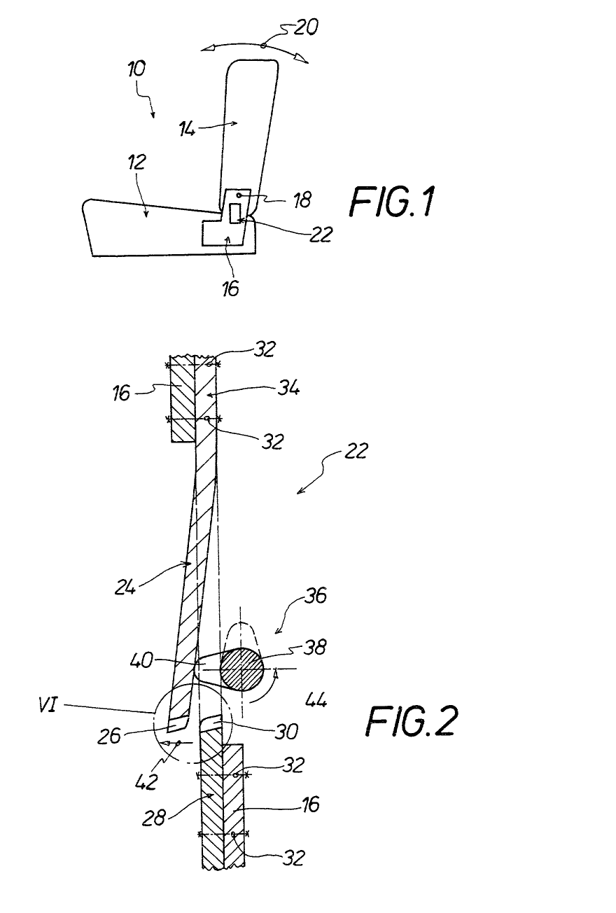

Referring firstly to FIG. 1, diagrammatically shown as a side view therein is a vehicle seat indicated generally at 10, comprising a seat squab 12 and a backrest 14 which are connected together pivotably by means of lateral seat fitments diagrammatically indicated at 16. The backrest 14 is thus adjustable about a pivot axis 18 in respect of its inclination in relation to the seat squab 12. This adjustment option is indicated by the double-headed arcuate arrow 20. The illustrated seat includes an adjusting arrangement generally indicated at 22 for adjusting the inclination of the backrest 14 relative to the seat squab 12.

Reference will now be made to FIG. 2 in which the sectional view thereof shows a portion of an embodiment of the adjusting arrangement 22 and more specifically essential component parts thereof. The adjusting arrangement 22 comprises a first member illustrated as a spring plate 24 having a tooth configuration 26 at its edge which is the lower edge in FIG. 2, and a counterpart retaining or detent member 28 which is fixed with respect to the seat and which has a counterpart tooth configuration 30 at its edge which is the upper edge in FIG. 2, the counterpart tooth configuration 30 thus corresponding to and being co-operable with the tooth configuration 26. In the embodiment of the adjusting arrangement 22 shown in FIG. 2 the counterpart member 28 is fixed to the seat fitment 16 of which a portion is shown in FIG. 2. That fixing is indicated by the thin dash-dotted lines 32. The spring plate 24 has a fixing portion 34 with which it is fixed to an associated portion of the fitment 16. That fixing is also indicated by thin dash-dotted lines 32.

Still referring to FIG. 2, reference numeral 36 denotes an actuating device which is operatively associated with the spring plate 24 and which comprises a shaft 38 mounted to the seat fitment 16, with an adjusting cam 40 carried on the shaft 38 and capable of bearing against the spring plate 24 at the side thereof which is towards the right in FIG. 2.

The adjusting cam 40 is shown in the retaining position of the actuating device 36 by a thin broken line, while it is shown in the release position of the actuating device 36 by a solid line. In a corresponding fashion the spring plate 24 is shown in the retaining position in thin broken lines while it is shown in the release position in solid lines. It will be noted from the Figure therefore that in the retaining position of the adjusting arrangement the tooth configuration 26 on the edge of the spring plate 24 is in latching engagement with the counterpart tooth configuration 30 of the counterpart member 28 which is fixed with respect to the seat. In the release position the tooth configuration 26 of the spring plate 24 is disengaged laterally, axially in respect of the teeth, from the counterpart tooth configuration 30 of the counterpart member 28. That lateral disengagement movement axially in relation to the teeth is indicated in FIG. 2 by the arrow 42 which is oriented in parallel relationship with the counterpart tooth configuration 30 of the counterpart member 28 and thus also the tooth configuration 26 of the spring plate 24.

When the actuating device 36 is displaced from the retaining position into the release position by rotational movement of the shaft 38 in the counter-clockwise direction, as indicated by the arcuate arrow 44, the spring plate 24 is deflected laterally axially in respect of the teeth in the direction of the arrow 42. At the same time the spring plate 24 is put under a mechanical stress. When the actuating device 36 is released again, the spring plate 24 is allowed to relax, in which case its tooth configuration 26 comes into latching engagement again in the counterpart tooth configuration 30 of the counterpart member 28. The two tooth configurations 26 and 30 are thus in play-free latching engagement in the normal arresting position of the arrangement so that the backrest is locked in position relative to the seat squab.

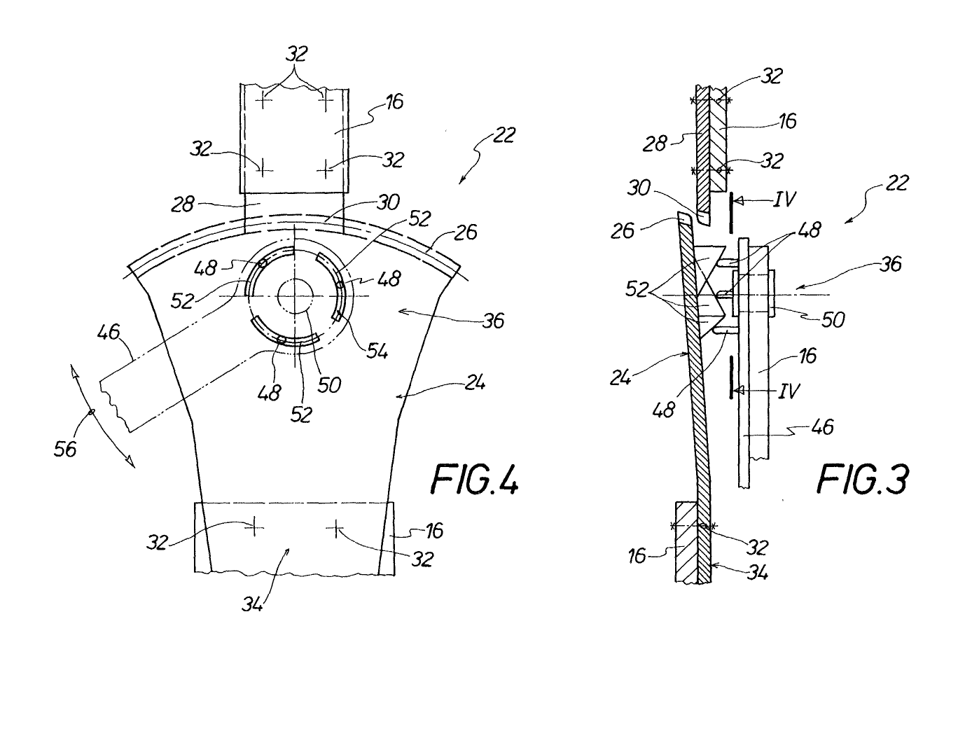

Reference will now be made to FIGS. 3 and 4 showing another embodiment of the adjusting arrangement 22 in which the actuating device 36 comprises a pivot lever 46 from which pressure members 48 project. The pivot lever 46 is mounted pivotably to the fitment 16 by means of a mounting trunnion 50. The spring plate 24, at its side towards the pivot lever 46, is provided with generally wedge-shaped ribs or projections which are indicated at 52 and the configuration of which can be clearly seen from FIG. 3. The pressure members 48 and the wedge-shaped ribs 52 are arranged along coincident circle portions indicated at 54 in FIG. 4, in equal numbers, at equal spacings from each other.

When the pivot lever 46 is pivoted about its central trunnion 50, as indicated by the arcuate arrow 56 in FIG. 4, the pressure members 48 of the pivot lever 46 which pivots about a fixed axis move along the wedge-shaped ribs 52. In that way, the spring plate 24 which is fixed with its fixing portion 34 to the seat fitment 16 is moved laterally axially in relation to the teeth away from the counterpart member 28 which is provided in fixed relation to the seat, in order to disengage the tooth configuration 26 of the spring plate 24 from the counterpart tooth configuration 30 of the counterpart member 28, or conversely the spring plate 24 is allowed to relax again so that the tooth configuration 26 of the spring plate 24 engages again into the counterpart tooth configuration 30 of the counterpart member 28 and the tooth configuration 26 is brought into latching engagement in a play-free condition with the counterpart tooth configuration 30.

It will be appreciated that components which are identical in FIGS. 3 and 4 to those in the structure described hereinbefore with reference to FIG. 2 are denoted by the same references and those components will therefore not be described once again in detail at this juncture with reference to FIGS. 3 and 4 for the avoidance of repetition. Reference to FIG. 2 will suffice for descriptive purposes in that respect.

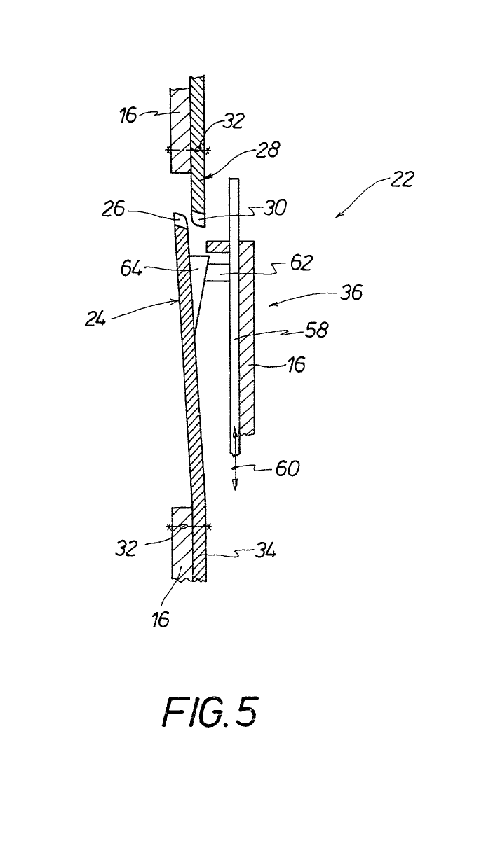

Reference will now be made to FIG. 5 showing a third embodiment of the adjusting arrangement 22 in which the actuating device 36 has a sliding lever 58 which is carried on the seat fitment 16 in a linearly movably guided fashion. That linear mobility is indicated by the arrow 60 in FIG. 5. The sliding lever 58 has a pressure member 62 which is displaceable along a wedge or taper portion 64 carried on the spring plate 24 at the side thereof which is towards the right in FIG. 5. It will be seen therefore that, as the pressure member 62 is displaceable along the taper portion 64, it will correspondingly cause spring deflection of the spring plate 24 in order to release the spring plate 24 with its tooth configuration 26 from the tooth configuration 30 axially in relation to the teeth, or to cause the tooth configuration 26 to come into play-free latching engagement again with the counterpart tooth configuration 30, by virtue of the spring plate 24 being mechanically relieved of stress so that it moves back towards the right in FIG. 5.

Once again it will be noted that the same components are denoted in FIG. 5 by the same references as in FIG. 2 so that they will not be described in full detail again at this point.

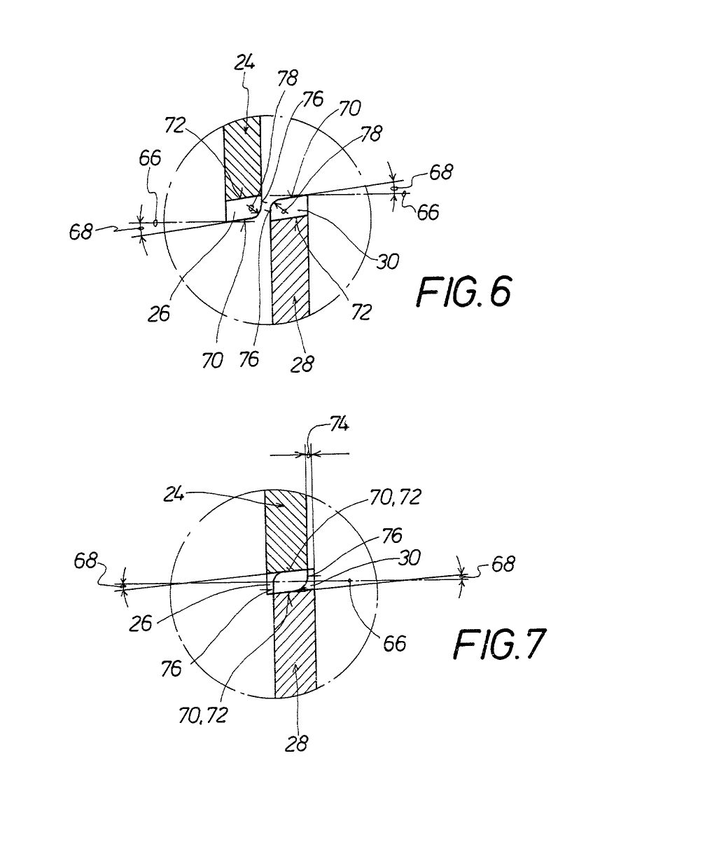

Attention will now be directed to FIG. 6 showing a view on an enlarged scale of a portion of the counterpart member 28 and a portion of the spring plate 24 in the release position of the adjusting arrangement, in which the spring plate 24 is displaced laterally and axially in relation to the teeth, with respect to the counterpart member 28. The tooth configuration 26 of the spring plate 24 and the counterpart tooth configuration 30 of the counterpart member 28 include an acute angle indicated at 68 with the common axis of the tooth configurations, which is indicated in FIG. 7 by the thin dash-dotted line 66 or which is indicated in FIG. 6 by respective thin dash-dotted lines associated with each of the spring plate 24 and the counterpart member 28. In this respect the teeth of the tooth configuration 26 and the teeth of the counterpart tooth configuration 28 are such that the tooth tips 70 and the tooth roots 72 are in mutually parallel relationship.

FIG. 7 shows that the tooth configuration 26 of the spring plate 24 and the tooth configuration 30 of the counterpart member 28 are of such dimensions in terms of diameter that, in the unused original condition, the spring plate 24 is displaced laterally and axially in relation to the teeth by a defined amount as indicated at 74 in FIG. 7, in relation to the counterpart member 28. That provides for automatic take-up adjustment of the spring plate 24 relative to the counterpart member 28 in the event of wear occurring after a long service life.

It will be noted that the tooth configuration 26 of the spring plate 24 and the counterpart tooth configuration 30 of the counterpart member 28 are rounded off at the transition between their tooth flanks 76 which face towards each other in the release position and the tooth tips 70, as can be clearly seen from FIG. 6. Those rounded configurations are indicated by the arrows 78.

It will be appreciated that the above-described embodiments of the adjusting arrangement according to the invention have been set forth solely by way of example and illustration of the principles of the invention and that various other modifications and alterations may be made therein without thereby departing from the spirit and scope of the invention.

What is claimed is:

1. An arrangement for adjusting the inclination of a backrest of a seat in relation to the seat squab, comprising
a spring plate having a tooth configuration and adapted to be mounted to one of the backrest and the seat squab,
a counterpart member having a counterpart tooth configuration co-operable with the tooth configuration of the spring plate, the counterpart member being adapted to be mounted to the other of the backrest and the seat squab, wherein the tooth configuration of the spring plate in an arresting position of the arrangement engages without play into the counterpart tooth configuration of the counterpart member, and
an actuating means operatively associated with the spring plate and displaceable between a retaining condition in which the tooth configurations are in engagement with each other and a release condition in which the tooth configuration of the spring plate is disengageable laterally axially in relation to the teeth out of the counterpart tooth configuration of the counterpart member.

2. An arrangement as set forth in claim 1 and further including
a seat fitment, and
means mounting the counterpart member, the spring plate and the actuating means to the seat fitment.

3. An arrangement as set forth in claim 2
wherein the spring plate includes a fixing portion fixed to the seat fitment.

4. An arrangement as set forth in claim 2
wherein the counterpart member includes a fixing portion fixed to the seat fitment.

5. An arrangement as set forth in claim 2
wherein the counterpart member is an integral component portion of the seat fitment.

6. An arrangement as set forth in claim 2
wherein the actuating means includes a shaft supported on the seat fitment, the shaft including an adjustment cam operable to bear against the spring plate.

7. An arrangement as set forth in claim 1
wherein the actuating means includes a pivot lever having pressure elements, and
wherein the spring plate includes wedge-shaped ribs thereon, the pressure elements and the wedge-shaped ribs being disposed along coincident circle portions for mutual co-operation.

8. An arrangement as set forth in claim 1 including
a taper portion on the spring plate, and
wherein the actuating means includes a slidable actuating member having a pressure element and displaceable along the taper portion for displacing said spring plate.

9. An arrangement as set forth in claim 1
wherein the tooth configuration and the counterpart tooth configuration include an acute angle with the common axis of the tooth configuration.

10. An arrangement as set forth in claim 9
wherein the acute angle is increased in the direction of opening of the spring plate in such a way that a self-locking action occurs in the retaining position.

11. An arrangement as set forth in claim 1
wherein the tooth configuration and the counterpart tooth configuration are rounded at the transitions between their tooth flanks which face towards each other in the release position and the tooth tips.

12. An arrangement for adjusting the inclination of a backrest of a seat in relation to the seat squab, comprising:
a first member having a first tooth configuration,
means for fixing the first member to one of the backrest and the seat squab,
a second counterpart member having a second tooth configuration adapted to co-operate with the first tooth configuration,
means for fixing the second counterpart member to the other of the backrest and the seat squab,
means biasing the first member towards a position in which the first tooth configuration is in retaining engagement without play with the second tooth configuration, and
an actuating means displaceable between a first condition in which the first and second tooth configurations are in said engagement with each other and a second condition in which the tooth configuration of the first member is disengaged laterally axially in relation to the teeth thereof out of the second tooth configuration of the second counterpart member.

13. An arrangement as set forth in claim 12
wherein said fixing means for fixing said first member are operable to fix said first member to said backrest.

14. An assembly comprising
a first member having a first tooth configuration,
a second member having a second tooth configuration, the first and second tooth configurations being adapted to co-operate with each other,
wherein the first and second tooth configurations include an acute angle with the common tooth axis.

15. An assembly as set forth in claim 14
wherein the first and second tooth configurations are rounded at the transitions between their tooth flanks which face towards each other and the tooth tips.
